(19) United States
(12) Patent Application Publication
(10) Pub. No.: US 2005/0215680 A1
(43) Pub. Date: Sep. 29, 2005

(54) Process for preparation of nucleated polyolefins

(75) Inventors: Subhash P. Vernekar, Pune (IN); Ramesh Chellaswamy, Pune (IN); S. Sivaram, Pune (IN)

Correspondence Address: DARBY & DARBY P.C., P. O. BOX 5257, NEW YORK, NY, 10150-5257, US

(73) Assignee: Council of Scientific and Industrial Research, New Delhi (IN)

(21) Appl. No.: 10/810,051

(22) Filed: Mar. 26, 2004

(51) Int. Cl. C08F 2/00

(52) U.S. Cl. 524/366; 524/394; 524/543

(57) ABSTRACT

The present invention provides a process for the preparation of gels of alkali and alkaline earth metal salts of organic carboxylic salts useful as nucleating agents for polyolefins and a process for incorporating nucleating agents in polyolefins in which a nucleating agent in solvent gel form is mixed with a polyolefin polymer by mechanical mixing and optionally compounded with other ingredients after removal of solvent by blowing air followed by extrusion resulting in a composition having higher crystallization temperature and smaller size of spherulites than the composition in which the nucleating agent is incorporated in polypropylene composition as a solid powder or by spraying solution of the nucleating agent in low boiling solvent.

### FIELD OF THE INVENTION

The present invention provides an improved process for preparation of nucleated polyolefins. More particularly it relates to the said process for nucleating polyolefins using a nucleating agent in a gel form. Still more particularly it relates using gels of alkali and alkaline earth metal salts of organic carboxylic salts, such as sodium benzoate gel.

### BACKGROUND OF THE INVENTION

In general the nucleated polyolefins are used in moulded articles household or industrial, in preparation of transparent articles, bottles with increased strength and transparency.

It is well known that incorporation of a nucleating agent (NA) in semi-crystalline thermoplastic polymers such as polypropylene increases crystallization temperature, reduces spherulitic size and improves clarity and mechanical properties of the polymer. Generally, nucleating agents are high melting compounds which do not melt at processing temperature of the polymer and remain as discrete particles embedded in polymer melt. These insoluble particles behave as nucleator for the crystallization of polymer melt and generate innumerable crystallization sites resulting innumerous small spherulites. Some nucleating agents are soluble in polymer melt but they solidify before crystallization of polymer melt and, thus, generate sites for crystallization. Apart from the structure, the size as well as the ability to disperse homogeneously in a melt of polymer also has profound effect on nucleation efficiency of a nucleating agent. Large number of particles having small size increases the number of nucleation sites and improves efficiency.

Generally, blending a nucleating agent as a powder with a base polymer along with other additives such as antioxidants, acid scavengers, dispersing agent, lubricant etc, followed by extrusion produces the nucleated polymer. Homogenous mixing of a nucleating agent in base polymer is essential for good results. Often the nucleating agent in powder form agglomerates to form bigger particles, thus reducing number of crystallization sites and hence reduction in efficiency of a nucleating agent. Thus, the method of incorporation of a nucleating agent in polymer has effect on its efficiency.

Generally, several classes of organic and inorganic compounds have been reported as efficient nucleating agents. Basically they can be classified as organic nucleating agents, which are generally soluble in the polymer melt and inorganic nucleating agents, generally insoluble in the polymer melt. Method of incorporation of these nucleating agents in polymer has effect on their efficiency.

U.S. Pat. No. 5,310,950 describes improvement in clarifying efficiency of acetals of sorbitol by reducing particle size of NA. The clarifying agent is in the form of powder characterized by a d₉₇ of 30 microns or less, and a mean particle size of 15 microns or less, is blended with the polyolefin resin, at a temperature above 170° C. until the clarifying agent is dissolved in the molten resin.

U.S. Pat. No. 4,184,026 describes a method in which nucleating agent dissolved in low boiling solvent is sprayed in polymer powder for uniform mixing of nucleating agent in polymer before processing.

Inorganic nucleating agents are generally considered as less efficient because of the difficulties associated with the efficient dispersal of the nucleating agent in the polymer. They tend to aggregate into large particles in polymer melt due to their intrinsic thermodynamic in compatibility causing loss of both nucleating efficiency as well as optical and mechanical properties. In the prior art the nucleation of the polyolefins is carried out using a nucleating agent in solid form or using a solution of the nucleating agent.

### OBJECTS OF THE INVENTION

The main object of this the present invention is to provide an improved process for nucleating polyolefins Another object of the present invention is to prepare a gel of alkali metal and alkaline earth metal salts of organic carboxylic acid in organic solvents to enable the material to be dispersed efficiently in a polyolefin.

Yet another object of the present invention is to obtain polyolefin with good optical and physical properties using alkali metal salts of carboxylic acids as nucleating agent.

### SUMMARY OF THE INVENTION

Accordingly, the present invention provides an improved process for nucleating polyolefins using the nucleating agent or mixture thereof in gel form optionally in combination with other additives such as antioxidants, antislip agents, acid scavengers, lubricants or UV absorbers, which comprises forming a gel of an nucleating agent either by dissolving the said nucleating agent in a solvent optionally heating the solution of the nucleating agent to the boiling point of the solvent used and cooling, or optionally by addition of another solvent, mixing the gel with a polypropylene powder optionally added with the other additives, removing the solvent by conventional methods, extruding the mixture at minimum temperature of melting point of the polyolefin to obtain the nucleated polyolefin.

In another embodiment the nucleating agent used for the nucleation of polyolefins may be metallic salts, for example but not restricted to, of sodium, potassium, lithium, calcium, magnesium, aluminum with organic carboxylic acids such as but not restricted to, aliphatic mono and dicarboxylic acids of 2-16 carbon atoms, preferably 2-8 carbon atoms, aromatic mono and poly carboxylic acids, substituted aromatic carboxylic acids and aliphatic and aromatic sulfonic acids.

In yet another embodiment the solvent used for dissolving the nucleating agent may be preferably solvent having low boiling points, but not restricted to, water, ketones containing 3-10 carbon atoms, preferably 3-7 carbon atoms, aliphatic alcohols containing 1-12 carbon atoms, preferably, 1-6 carbon atoms, aliphatic esters, ethers, cyclic ethers, hydrocarbons of 5-15 carbon atoms or a mixture of hydrocarbons, aromatic hydrocarbons such as toluene, xylene etc., petrol, kerosene, chlorinated hydrocarbons, dimethylformamide, dimethyl acetamide, dimethyl sulfoxide.

In still another embodiment the solvent used for gelling the nucleating agent may be a solvent or a nonsolvent to the solvent used for preparing solution of the nucleating agent exemplified by alcohols or ketones or aliphatic or aromatic hydrocarbons or esters such as methanol, ethanol, toluene, xylene, n-hexane, cyclohexane, acetone, MIBK, ethylacetate rtc.

In yet another embodiment the quantity of nucleating agent in gel used in polyolefin may be 0.01 to 10 wt %, preferably 0.01 to 2 wt % and more preferably 0.1 to 0.5 wt % based on polyolefins.

### DETAILED DESCRIPTION OF THE INVENTION

The present invention provides an improved process for nucleating polyolefins using one or more nucleating agent in gel form. Optionally other additives such as antioxidants, antislip agents, acid scavengers, lubricants or UV absorbers may also be added to the mixture of the polyolefin and the nucleating agent gel. The gel of the nucleating agent is formed by dissolving the nucleating agent in a solvent and optionally heating the solution to boiling point of the solvent used and then cooling. Alternatively, another solvent is added to the solution of the nucleating agent to gel the agent. The second solvent may be a solvent or a non-solvent for the first solvent.

The nucleating agent gel is then mixed with the polyolefin powder which could for example be polypropylene powder optionally with other additives. The solvent is then removed by conventional methods and the mixture extruded at minimum temperature of melting point of the polyolefin to obtain the nucleated polyolefin.

The nucleating agent used for the nucleation of polyolefins are metallic salts, for example but not restricted to salts of sodium, potassium, lithium, calcium, magnesium, aluminum with organic carboxylic acids such as but not restricted to, aliphatic mono and dicarboxylic acids of 2-16 carbon atoms, preferably 2-8 carbon atoms, aromatic mono and poly carboxylic acids, substituted aromatic carboxylic acids and aliphatic and aromatic sulfonic acids.

The solvent used for dissolving the nucleating agent is preferably solvent having low boiling points, such as but not restricted to, water, ketones containing 3-10 carbon atoms, preferably 3-7 carbon atoms, aliphatic alcohols containing 1-12 carbon atoms, preferably, 1-6 carbon atoms, aliphatic esters, ethers, cyclic ethers, hydrocarbons of 5-15 carbon atoms or a mixture of hydrocarbons, aromatic hydrocarbons such as toluene, xylene etc., petrol,
kerosene, chlorinated hydrocarbons, dimethylformamide, dimethyl acetamide, dimethyl sulfoxide.

The second solvent used for gelling the nucleating agent is a solvent or a nonsolvent to the solvent used for preparing solution of the nucleating agent exemplified by alcohols or ketones or aliphatic or aromatic hydrocarbons or esters such as methanol, ethanol, toluene, xylene, n-hexane, cyclohexane, acetone, MIBK, ethylacetate rtc.

The quantity of nucleating agent in gel used in polyolefin is 0.01 to 10 wt %, preferably 0.01 to 2 wt % and more preferably 0.1 to 0.5 wt % based on polyolefins.

In a feature of the present invention the polyolefins may be homopolymers, copolymers of olefin with one or more ethylenically unsaturated comonomers. Generally, the comonomer, if present, is provided in minor quantities about 10% or even lower percent based on the weight of olefin. Such comonomers are provided to modify the properties of polymers. Examples of the polymers whose transparency can be improved by incorporation of nucleating agent include polymer and copolymers of aliphatic mono olefins containing two to about six carbon atoms having molecular weight of about 30,000 to about 5,00,000, preferably from 30,000 to about 3,00,000 such as polyethylene, polypropylene, ethylene-propylene copolymers.

In another feature the solvent gel of nucleating agent is mixed with polymer little at a time by blending mechanically or by any suitable method of blending followed by removal of solvent by suitable methods such as exposing to air/heating in oven or air circulated oven at ˜50° C. This blend is further compounded with other additives and extruded.

In still another feature the solvent in gel can be removed by heating at low temperature in an oven, preferably, air circulated oven or exposing to atmosphere.

The process of the present invention is described hereinbelow with reference to examples which are given by way of illustration and should not be constrained to limit the scope of the present invention.

### EXAMPLE-1

This example illustrated the use of sodium benzoate gel in methyl isobutyl ketone (MIBK)—for nucleating. 0.2 g of gel was mixed with 100 g of polypropylene resin (MFI 12) in small lot of 10 gm each at a time followed by stirring to ensure efficient mixing. After complete mixing, the resin was dried in an air circulated oven over night at room temperature to remove any residual solvent. This resin was further compounded with additives namely, Irganox1010, 500 ppm; Ultranox-626, 800 ppm; Hydrotalcite DHT 4A, 200 ppm; Calcium stearate, 500 ppm; GMS-Finast 9500, 400 ppm on a Brabander single screw extruder. The extrusion temperature profile was 170-180-200-210° C. The screw RPM was 60. The residence time was 30 seconds. The extruded material was pelletized to obtained the product.

Sodium benzoate (0.2 g) was dissolved in methanol (7 mL) in a 100 mL beaker to which methyl isobutylketone (45 mL) was added drop wise with magnetic stirring. A gel with bluish tinge was formed. 0.2 g of salt, prepared by methods described in above examples, were mixed with 100 g of polypropylene resin (MFI 12) in small lot of 5-10 gm each at a time followed by stirring to ensure efficient mixing. After complete mixing, the resin was dried in an air circulated oven over night at room temperature to remove any residual solvent. This resin was further compounded with additives namely, Irganox1010, 500 ppm; Ultranox-626, 800 ppm; Hydrotalcite DHT 4A, 200 ppm; Calcium stearate, 500 ppm; GMS-Finast 9500, 400 ppm on a Brabander single screw extruder. The extrusion temperature profile was 170-180-200-210° C. The screw RPM was 60. The residence time was 30 seconds. The extruded material was pelletized.

### EXAMPLE-2

Preparation of acetone-sodium benzoate gel: Sodium benzoate (0.2 g.) was dissolved in methanol (7.0 mL) in a 100 mL beaker to which acetone (40 mL) was added drop by drop with magnetic stirring. A gel was formed. 0.2 g of salt, prepared by methods described in above examples, were mixed with 100 g of polypropylene resin (MFI 12) in small lot of 5-10 gm each at a time followed by stirring to ensure efficient mixing. After complete mixing, the resin was dried in an air circulated oven over night at room temperature to remove any residual solvent. This resin was further compounded with additives namely, Irganox1010, 500 ppm; Ultranox-626, 800 ppm; Hydrotalcite DHT 4A, 200 ppm; Calcium stearate, 500 ppm; GMS-Finast 9500, 400 ppm on a Brabander single screw extruder. The extrusion temperature profile was 170-180-200-210° C. The screw RPM was 60. The residence time was 30 seconds. The extruded material was pelletized.

### EXAMPLE-3

Preparation of acetone-toluene-sodium benzoate gel: In a beaker (50 mL), NaOH (0.108 gm) moistened with 4 drops of water was dissolved in alcohol (1.5 mL). To this solution benzoic acid (0.33 g) dissolved in acetone (13 mL) was added drop wise with stirring. A gel is formed. To this gel, toluene (15+10 mL) was added in two installments. A transparent solution was formed. 0.2 g of salt, prepared by methods described in above examples, were mixed with 100 g of polypropylene resin (MFI 12) in small lot of 5-10 gm each at a time followed by stirring to ensure efficient mixing. After complete mixing, the resin was dried in an air circulated oven over night at room temperature to remove any residual solvent. This resin was further compounded with additives namely, Irganox1010, 500 ppm; Ultranox-626, 800 ppm; Hydrotalcite DHT 4A, 200 ppm; Calcium stearate, 500 ppm; GMS-Finast 9500, 400 ppm on a Brabander single screw extruder. The extrusion temperature profile was 170-180-200-210° C. The screw RPM was 60. The residence time was 30 seconds. The extruded material was pelletized.

### EXAMPLE-4

Preparation of methyl isobutyl ketone-sodium benzoate-toluene gel: Sodium benzoate (0.2 gm) was dissolved in methanol (7.0 mL) to which MIBK (25 mL) was added drop by drop with magnetic stirring. A gel with slight bluish tinge was formed. This was diluted with toluene (25 mL) to form an almost transparent liquid. The particles dispersed in the liquid had an average size of ˜40 nano meters. 0.2 g of salt, prepared by methods described in above examples, were mixed with 100 g of polypropylene resin (MFI 12) in small lot of 5-10 gm each at a time followed by stirring to ensure efficient mixing. After complete mixing, the resin was dried in an air circulated oven over night at room temperature to remove any residual solvent. This resin was further compounded with additives namely, Irganox1010, 500 ppm; Ultranox-626, 800 ppm; Hydrotalcite DHT 4A, 200 ppm; Calcium stearate, 500 ppm; GMS-Finast 9500, 400 ppm on a Brabander single screw extruder. The extrusion temperature profile was 170-180-200-210° C.; The screw RPM was 60. The residence time was 30 seconds. The extruded material was pelletized.

### EXAMPLE-5

Preparation of acetone-sodium benzoate-toluene gel: Sodium benzoate (0.2 g) was dissolved in methanol (7.0 mL) to which acetone (25 mL) was added drop by drop with magnetic stirring. A gel with slight bluish tinge was formed. This was diluted with toluene (25 mL). It forms almost transparent liquid. This liquid was mixed with polypropylene resin. 2 g of salt, prepared by methods described in above examples, were mixed with 100 g of polypropylene resin (MFI 12) in small lot of 5-1.0 gm each at a time followed by stirring to ensure efficient mixing. After complete mixing, the resin was dried in an air circulated oven over night at room temperature to remove any residual solvent. This resin was further compounded with additives namely, Irganox1010, 500 ppm; Ultranox-626, 800 ppm; Hydrotalcite DHT 4A, 200 ppm; Calcium stearate, 500 ppm; GMS-Finast 9500, 400 ppm on a Brabander single screw extruder. The extrusion temperature profile was 170-180-200-210° C. The screw RPM was 60. The residence time was 30 seconds. The extruded material was pelletized.

### EXAMPLE-6

Solution of sodium benzoate in water: Sodium benzoate (0.2 g) was dissolved in water (100 mL). This solution was spray mixed with polypropylene resin (100 g). 0.2 g of salt, prepared by methods described in above examples, were mixed with 100 g of polypropylene resin (MFI 12) in small lot of 5-10 gm each at a time followed by stirring to ensure efficient mixing. After complete mixing, the resin was dried in an air circulated oven over night at room temperature to remove any residual solvent. This resin was further compounded with additives namely, Irganox1010, 500 ppm; Ultranox-626, 800 ppm; Hydrotalcite DHT 4A, 200 ppm; Calcium stearate, 500 ppm; GMS-Finast 9500, 400 ppm on a Brabander single screw extruder. The extrusion temperature profile was 170-180-200-210° C. The screw RPM was 60. The residence time was 30 seconds. The extruded material was palletized. The main advantage of present invention is significant improvement in crystallization temperature (Tc) and reduction in spherulitic size of crystals of polyolefins thus, improving optical properties of polyolefins using alkali/alkaline metal salts of carboxylic acids.

TABLE 1
Tc of PP nucleated with sodium benzoate:

| | Tc | Tc (Onset) | Spherulitic |
|---|---|---|---|
| Examples | ° C. | ° C. | size μ |
| Example-1 | 113 | 118 | 4 |
| Example-2 | 110 | 115 | 10 |
| Example-3 | 113 | 118 | — |
| Example-4 | 114 | 119 | 4 |
| Example-5 | 112 | 118 | 9 |
| Comparative | 109 | 115 | 10 |
| Example-6 | | | |
| Comparative | 109 | 115 | 24 |
| Example-7 | | | |

1. A process for the preparation of nucleated polyolefins, which process comprises forming a gel of one or more nucleating agents by dissolving the nucleating agent in a solvent, mixing the gel with a polyolefin powder, removing the solvent and extruding the mixture at the minimum temperature of the melting point of the polyolefin to obtain the nucleated polyolefin.

2. A process as claimed in claim 1 wherein one or more additives selected from the group consisting of antioxidants, antislip agents, acid scavengers, lubricants and UV absorbers is added to the gel of one or more nucleating agent before mixing with the polyolefin.

3. A process as claimed in claim 1 wherein the gel of the one or more nucleating agent is prepared by dissolving the one or more nucleating agent in a solvent and heating the solution to the boiling point of the solvent and cooling the solution.

4. A process as claimed in claim 1 wherein a second solvent is added to the solution of the one or more nucleating agent to gel the nucleating agent.

5. A process as claimed in claim 1 wherein the polyolefin is polypropylene.

6. A process as claimed in claim 1 wherein the nucleating agent comprises a metallic salt selected from the group consisting of salts of sodium, potassium, lithium, calcium, magnesium, aluminum with organic carboxylic acids.

7. A process as claimed in claim 6 wherein the organic carboxylic acid is selected from the group consisting of aliphatic mono and dicarboxylic acids of 2-16 carbon atoms, aromatic mono and poly carboxylic acids, substituted aromatic carboxylic acids and aliphatic and aromatic sulfonic acids.

8. A process as claimed in claim 6 wherein the organic carboxylic acid is selected from the group consisting of aliphatic mono and dicarboxylic acids of 2-8 carbon atoms.

9. A process as claimed in claim 1, wherein the solvent used for dissolving the nucleating agent is selected from the group consisting of water, ketones containing 3-10 carbon atoms, aliphatic alcohols containing 1-12 carbon atoms, aliphatic esters, ethers, cyclic ethers, hydrocarbons of 5-15 carbon atoms, mixture of hydrocarbons, aromatic hydrocarbons, petrol, kerosene, chlorinated hydrocarbons, dimethylformamide, dimethyl acetamide and dimethyl sulfoxide.

10. A process as claimed in claim 1, wherein the solvent used for dissolving the nucleating agent comprises ketones preferably 3-7 carbon atoms.

11. A process as claimed in claim 1, wherein the solvent used for dissolving the nucleating agent comprises aliphatic alcohols having 1-6 carbon atoms.

12. A process as claimed in claim 9, wherein the aromatic hydrocarbon solvent is selected from toluene and xylene.

13. A process as claimed in claim 4, wherein the second solvent used for gelling the nucleating agent may be a solvent or a nonsolvent to the solvent used for preparing solution of the nucleating agent.

14. A process as claimed in claim 4, wherein the second solvent used for gelling the nucleating agent is selected from the group consisting of alcohols, ketones, aliphatic hydrocarbons, aromatic hydrocarbons and esters.

15. A process as claimed in claim 4, wherein the second solvent used for gelling the nucleating agent is selected from the group consisting of methanol, ethanol, toluene, xylene, n-hexane, cyclohexane, acetone, MIBK and ethylacetate.

16. A process as claimed in claim 1, wherein the quantity of nucleating agent gel to polyolefin is in the range of 0.01 to 10 wt % based on polyolefins.

17. A process as claimed in claim 16, wherein the quantity of nucleating agent gel to polyolefin is in the range of 0.01 to 2 wt % based on polyolefins.

18. A process as claimed in claim 16, wherein the quantity of nucleating agent gel to polyolefin is in the range of 0.1 to 0.5 wt % based on polyolefins.

19. A process as claimed in claim 1, wherein the polyolefin is selected from the group consisting of homopolymers or copolymers of olefin with one or more ethylenically unsaturated comonomers.

20. A process as claimed in claim 19, wherein the comonomer is provided in an amount of 10% or less based on the weight of olefin.

21. A process as claimed in claim 1, wherein the polyolefin comprises polymers and copolymers of aliphatic mono olefins containing two to six carbon atoms and having molecular weight of about 30,000 to about 5,00,000.

22. A process as claimed in claim 1, wherein the polyolefin comprises a polymer or copolymer having a molecular weight in the range of 30,000 to 3,00,000.

23. A process as claimed in claim 1, wherein the polyolefin is selected from the group consisting of polyethylene, polypropylene and ethylene-propylene copolymers.

24. A process as claimed in claim 1, wherein the gel of nucleating agent is mixed with the polyolefin gradually by mechanical blending mechanically followed by removal of solvent by exposing to air or heating in an oven or an air circulated oven at a temperature of about 50° C.

25. Process as claimed in claim 1 wherein the nucleating agent gel is sodium benzoate gel.
